(19) United States
(12) Patent Application Publication
(10) Pub. No.: US 2002/0183995 A1
(43) Pub. Date: Dec. 5, 2002

(54) System and method for simulating railroad rail testing

(76) Inventors: Alastair Veitch, Brookfield, CT (US); John Galant, Dayton, OH (US)

Correspondence Address: J. Michael Martinez de Andino, HUNTON & WILLIAMS, Riverfront Plaza, East Tower, 951 East Byrd Street, Richmond, VA, 23219-4074, US

(21) Appl. No.: 09/874,180

(22) Filed: Jun. 5, 2001

(51) Int. Cl. G06G 7/48

(52) U.S. Cl. 703/7

(57) ABSTRACT

The system and method of the invention is a rail test simulator for training operators of rail inspection systems. More particularly it is a simulator that simulates the visual cues characteristic of a rail inspection in a synchronized manner with data of the type acquired by rail testing equipment, such that an operator of the simulator may experience instrumental data and visual cues characteristic of a rail inspection and be provided an opportunity for response to the data and visual cues which mimic the conditions, options, circumstances and/or physical choices of an actual rail inspection. The data presented may be ultrasonic data, induction data, both ultrasonic and induction data or any other type of data that may be correlated with rail defects. Preferably, the simulator has the capacity to replicate all functions of an actual inspection vehicle. For example, it has provision for simulating a closer inspection of specific areas of the track by including controls that simulate the stopping, reversing and speed variation controls of an actual testing vehicle. Further, the simulator optionally includes the capability of recording and replaying a simulation to review operator performance.

### BACKGROUND OF THE INVENTION

1. Field of the Invention

This invention generally relates to a system and method for simulating a railroad rail inspection. More particularly, the invention relates to a system and method for training an operator of rail inspection system.

2. Background Art

In the wake of several train derailments in the 1920s, it was determined that non-destructive testing methods for locating structural flaws in railroad rail was needed. Initial work focused on an approach wherein a current was applied to the rail and a drop in voltage was used to determine the presence of a discontinuity within the rail. Later, ultrasonic techniques were applied to rail inspection. In the typical ultrasonic inspection unit, ultrasonic transducers are installed in pliable wheels that ride over the upper surface of the rail. The wheels are filled with a coupling fluid and are in contact with the rails under pressure. The transducers are arranged to send ultrasonic signals at different angles though the coupling fluid and into the rail and especially the railhead. The return signals are processed and used to map the location of flaws in the rail.

Rail inspection is typically accomplished by a vehicle traveling along a railroad track recording ultrasonic and/or induction data in real time from the rails as the vehicle passes over the rails. The inspection vehicle includes a system that automatically detects defects in the rails and sounds an alarm to alert the operator. The operator can stop the vehicle at any time for closer inspection of specific areas of the track. The operator is given further flexibility for closer inspection by having the ability to reverse the inspection vehicle and vary the speed of the inspection vehicle.

While ultrasonic and induction systems for detecting defects are useful, the skill and observation abilities of the personnel operating the equipment are critical to the overall effectiveness of detection of defects. Particularly important is the ability of experienced personnel to note anomalies by simply watching the track as testing equipment is collecting data.

Complications to detection of flaws by ultrasonic or induction testing method are attributable to several factors. The first of these is that there are many types of rail defects. Rail defects can occur in the railhead, web or base. Defects are usually the result of impurities in the original ingots that were elongated during the forging process to form the rail. Depending on the nature of the impurity, the resulting flaw can grow along the axis of the rail or transverse to the axis. Transverse defects may also result from surface-induced anomalies such as work hardening of the railhead. Some of the more common defects and their classifications are described below:

A transverse fissure is one type of defect. This type of defect is usually centrally located in the railhead and results from an oxide inclusion or other small impurity that causes a “stress riser” in the rail. Growth of the inclusion flaw is promoted by the constant flexing of the rail. This growth generally continues until the rail eventually fractures.

A detail fracture is a further type of defect. This type of transverse defect usually occurs as a result of the work hardening of the railhead. This causes a split in the railhead and a transverse separation that typically begins at the gage side of the rail. Another mechanism for this type of rail failure is an anomaly known as “shell.” A shell is usually caused by a horizontally oriented, axle, linear impurity, i.e., a “stringer” that becomes elongated and flattened during use. A shell is not usually classified as a defect in itself. However, it is common for such a condition to subsequently result in a transverse defect.

A “vertical split head” is a further type of defect. A railhead stringer that is vertically oriented can grow in the vertical plane along the axis of the rail. This is referred to as a vertical split head and is potentially an extremely serious type of defect as it can result in the loss of the running surface of the rail. A horizontal split head usually originates from a longitudinal seam or an inclusion. Growth usually occurs rapidly along the length of the inclusion and spreads horizontally.

A “head and web separation” is a further type of defect. This type of defect is usually found at the end of the rail, i.e., at a joint. Such separation is believed to occur due to the eccentric loading at the end of the rail. This separation occurs at the weakest point, which is where the railhead joins the web at the fillet.

A “bolt hole crack” is a further type of defect. This type of defect is usually the result of stresses applied to the edge of a bolt hole by the bolt. Such stresses are produced due to the cycling up and down of the joint as the train passes over it. The effect may be worsened by worn joint bars or improper drilling.

An “engine burn fracture” is a further type of defect. Such a defect results from wheel slippage during acceleration of a locomotive from a standstill. Rapid heating and cooling causes thermal cracks that are exacerbated by the train wheels pounding the area. Transverse separation can occur as a result.

A “defective weld” is a further type of defect. Weld defects may vary according to the weld type. In general there are welds that are made during rail manufacture and there are welds that are made on site while the rail is being installed or repaired. Manufacturing welds are usually “flash butt” welds. Welds made in the field are mostly “thermite” welds. Defects that are germane to the flash butt type of weld are for the most part fusion type flaws. Thermite welding is actually a type of casting operation where a mold is situated around the profile of the rail and the molten metal is allowed to flow between the mating surfaces. The flaw possibilities from a thermite weld can be more diverse, ranging from lack of fusion to porosity to other non-metallic inclusions.

A second complicating factor in rail testing, in addition to the rail defects described above, is the fact that rails come in a variety of shapes and sizes. The accessible scanning surface for the instrumentation, which is usually the railhead, is extremely non-uniform. In addition to variability of the rails as manufactured, head shape changes over time as a result of use by high-speed, high axle-load trains. The resulting non-uniformity of the rail geometry renders it difficult to maintain the contact of sensory equipment with the railhead. The difficulty is exacerbated by curves, crossings and switches.

A third factor is the surface condition of the railhead. A railhead having rust, grease or other foreign matters such as leaves on the surface can severely inhibit the transfer of energy from an ultrasonic transducer mounted within the pliable wheels of the search unit. This limits the sensor's sensitivity. Further, steel slivers that develop on the railhead surface may physically damage the testing equipment.

A fourth factor that impacts the efficacy of test equipment is weather conditions. The formation of ice in particular can make testing extremely difficult. This is particularly unfortunate since weather can be a significant factor in flaw propagation. Contraction of the rail due to cold temperature combined with heavy train axle loads are very conducive to flaw separation, particularly when a train has a flat spot on a wheel that happens to contact a rail at a critical location relative to the flaw. Thus, testing under extreme weather conditions is often necessary.

It should be appreciated that a large investment of time is required to train an operator to operate the testing equipment and learn to recognize the visual cues from observation of the track that supplement the test equipment data and lead to effective detection of flaws in the presence of the aforementioned limitations. In known practices, training only takes place during actual track inspection with an experienced operator overseeing the trainee. As a result, it can take between one to two years to fully train an operator. The problem has been further compounded by the general reduction in time allocated by the railroads for track testing and the need to meet increased track inspection frequencies. Thus, there is the need for a system to effectively train rail inspection vehicle operators to assess testing data and coordinate the testing data with visual cues independent from actual rail inspections.

### SUMMARY OF THE INVENTION

The present invention is a rail test simulator for training operators of rail inspection systems. More particularly, it is a simulator that simulates the visual cues characteristically observed during a rail inspection in a synchronized manner with data of the type acquired by rail testing equipment, such that an operator of the simulator may experience test data and visual images characteristic of a rail inspection and be provided an opportunity for response to the data and visual cues which mimic the conditions, options, circumstances and/or physical choices of an actual rail inspection.

For example, in the simulator system of the invention, visual images are synchronized with corresponding inspection data which is presented to the operator via a modified strip chart recorder, digital chart display, computer terminal or similar display technique. The data presented may be ultrasonic data, induction data, both ultrasonic and induction data or any other type of data that may be correlated with rail defects. Preferably, the simulator has the capacity to replicate all functions of an actual inspection vehicle. For example, the simulator may include an audible defect alarm comparable to one found in the actual testing vehicle and have provision for simulating a closer inspection of specific areas of the track by including controls that simulate the stopping, reversing and speed variation controls of an actual testing vehicle. Further, the simulator may include the capability of recording and replaying a simulation to review operator performance. As one skilled in the art understands, this is one example of the many types of data or options that can be presented to an operator.

In addition to accomplishing the purpose of training operators, the simulator is also useful for testing experienced operators reading and interpretation skills for key types of defects; providing operator exposure to defects that, in real life, may only be experienced once or twice a year; training operators to use new types of test equipment or detect new types of track defects; and for operator refresher course training, for example. The simulator allows the operator to experience many different types of real conditions without the need to travel along miles of rail.

One example of the simulator, according to the present invention, provides both out-the-window visual images and inspection system test data to the simulator user. This is accomplished by displaying digitally recorded imagery of the appearance of the track and surrounding area as it would appear if observed from a testing vehicle, along with reproduced test data similar to that obtained from the actual vehicle. The digital imagery is synchronized with, for example, the corresponding ultrasonic inspection and/or induction data that is presented to the user.

Accordingly, an illustrative system in accordance with one embodiment of the invention is a rail test simulator that includes a first apparatus and a second apparatus. The first apparatus records visual and rail test data of the type obtained by a rail test vehicle. The first apparatus includes a visual image recording portion for recording a plurality of visual images and a data recording portion for recording data of the type associated with rail inspection. The second apparatus simulates an actual rail inspection. The second apparatus includes a visual image portion having capability for presenting a plurality of the visual images. The second apparatus also includes a data input portion that presents data of the type associated with a rail inspection, a control portion for creating a response to the at least one test scenario, and an adjustment portion which can initiate an alteration in at least one of the visual image portion and data input portion in a selective manner in the event that a response is created by the control portion. Further at least one of the first apparatus and the second apparatus has a synchronizing capability for synchronizing the visual images with the test data to create a least one test scenario.

The system may also include a recorder which has the capacity to record events associated with use of the apparatus. That is, the recorder may record select information during the training session of an operator.

The plurality of visual images recorded by the visual image recording portion and the data of the type associated with a rail inspection, which is recorded by the data recording portion, may be obtained during an actual rail inspection. Alternatively, the plurality of data of the type associated with a rail inspection recorded by the data recording portion may be obtained by a data simulation, i.e., that data may be artificially created using a computer, for example.

The apparatus for simulating a rail inspection in a test vehicle may include a data input portion that inputs at least one of an ultrasonic rail test data and an induction rail test data, for example. Also, the apparatus for simulating a rail inspection in a test vehicle may include a control portion having the capability for creating the response simulating at least one of stopping the test vehicle, slowing the test vehicle and reversing the test vehicle.

The rail test simulator system of the invention for training an operator comprises a rail test data recorder for obtaining obtained rail test data and a rail inspection simulator that simulates a track inspection. The rail test data recorder further includes a visual image recording portion for recording obtained visual data and a data recording portion for recording a plurality of track data representing a condition of the track. Obtained rail test data includes obtained visual data and obtained track data. The rail inspection simulator includes a visual generation portion that generates generated visual images, a track generation portion that generates generated track data and a controller that inputs the obtained rail test data from the rail test data recorder and provides obtained visual data to the visual image generation portion and obtained track data to the track generation portion. The controller further includes an operator interface portion which accepts operator input from an operator. Further the controller provides the obtained test rail data to the visual image generation portion and the obtained track data to the track generation portion based on the operator input.

### BRIEF DESCRIPTION OF THE DRAWINGS

FIG. 1 is a block diagram of a rail test simulator in accordance with one embodiment of the system and method of the invention;

FIG. 2 is a block diagram of the data input control portion of the rail test simulator shown in FIG. 1 in accordance with one embodiment of the system and method of the invention;

FIG. 3 is a block diagram of the rail inspection simulation portion of the rail test simulator shown in FIG. 1 in accordance with one embodiment of the system and method of the invention;

FIG. 4 is a diagram of one embodiment of the system and method of the invention and includes a vehicle recording system and a playback simulator in accordance with one embodiment of the system and method of the invention;

FIG. 5 is a diagram of a vehicle recording system for a rail test simulator that acquires test data and visual images during an actual rail inspection in accordance with one embodiment of the system and method of the invention;

FIG. 6 is a diagram showing a vehicle recording system user interface in accordance with one embodiment of the system and method of the invention;

FIG. 7 is a diagram showing an example of a data indexing system in a vehicle recording system in accordance with one embodiment of the system and method of the invention;

FIG. 8 is a diagram showing a digital image synchronizing system in a vehicle recording system in accordance with one embodiment of the system and method of the invention;

FIG. 9 is a diagram showing a data process timing in a vehicle recording system in accordance with one embodiment of the system and method of the invention;

FIG. 10 is a diagram showing a data storage allocation for a vehicle recording system in accordance with one embodiment of the system and method of the invention;

FIG. 11 is a diagram showing a playback simulator for an inspection simulation portion in a rail test simulator in accordance with one embodiment of the system and method of the invention;

FIG. 12 is a diagram showing an operator control interface of a playback simulator in a rail inspection simulator in accordance with one embodiment of the system and method of the invention;

FIG. 13 is a diagram showing a user interface which controls the loading and playback of simulator data in accordance with one embodiment of the system and method of the invention; and

FIG. 14 is a schematic representation of a data input control portion wherein data is selectively compiled in accordance with one embodiment of the system and method of the invention.

### DETAILED DESCRIPTION OF THE INVENTION

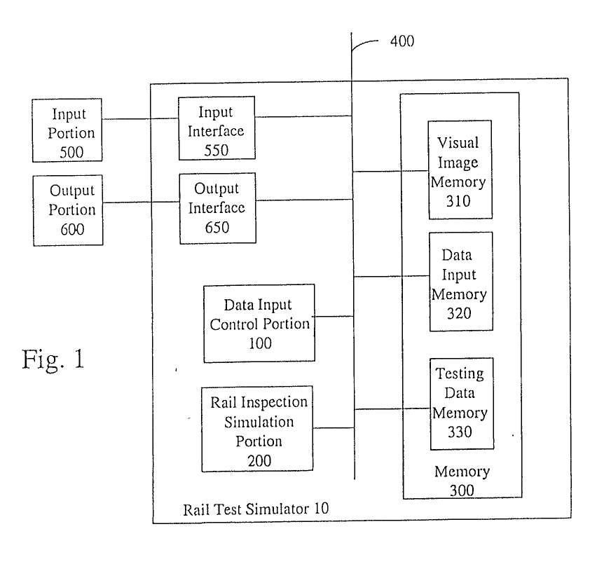

FIG. 1 shows a rail test simulator 10 in accordance with an embodiment of the invention. As shown in FIG. 1, the rail test simulator 10 includes a data input control portion 100, a rail inspection simulation portion 200 and a memory 300. The memory 300 includes a visual image memory 310 which stores visual images, a data input memory 320 which stores instrument test data and a testing data memory 330 for storing information related to the use of the simulator. Additionally, the rail inspection simulator includes an input portion 500, an input interface 550. an output portion 600, and an output interface 650. The input portion 500 may be any of a number of types of components or devices to input information into the rail testing simulator 10. The input portion 500 interfaces with the rail test simulator 10 through the input interface 550. The output portion 600 interfaces with the rail test simulator 10 through the output interface 650, and outputs information from the rail test simulator 10.

As shown in FIG. 1, an interface 400 provides communication between the various components of the rail test simulator 10. Specifically, the interface 400 provides communication between the data input control portion 100, the rail inspection simulation portion 200, and the memory 300.

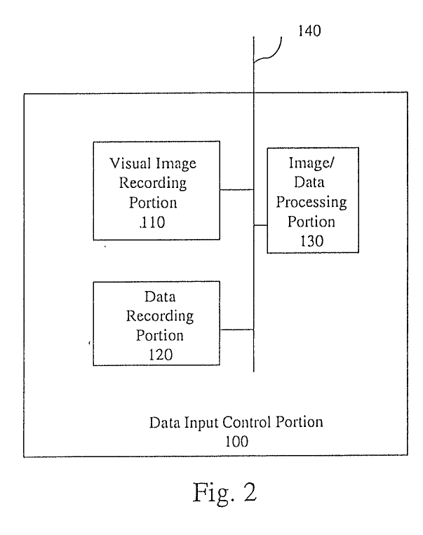

FIG. 2 shows in further detail the data input control portion 100 of FIG. 1. The data input control portion 100 as shown in FIG. 2, includes a visual image recording portion 110, a data recording portion 120 and an image/data processing portion 130. The data input control portion 100 of the rail test simulator 10 collects, stores and optionally synchronizes the visual images and test data presented to the operator of the rail test simulator 10 in a test scenario.

As shown in FIG. 2, the visual image recording portion 110 captures and records visual images associated with a rail inspection. For example, this may be accomplished by a variety of methods including, but not limited to, recording images viewed from a rail inspection vehicle during the process of an inspection, creating and recording computer generated images or a combination of such methods.

The data recording portion 120 of the data input control portion 100 captures and records test data of the type generated during a rail inspection. This may include, for example, but is not limited to, ultrasonic test data, induction test data or a combination of ultrasonic and induction test data. The test data may be acquired and recorded during an actual rail inspection. Specifically, the output of test data from test equipment of a rail inspection vehicle may be input into the data recording portion 120. The data recording portion 120 then creates, based on the input data, a recording of actual test data during an inspection. Alternatively, the data may be derived from data spliced together from more than one rail inspection; be derived from data generated artificially; or may be acquired in a way that combines use of actual test data and artificially generated data. Additionally, when the data recording portion 120 is acquiring data during an actual rail inspection, the acquisition of data may be selectively started and stopped to collect specific data and corresponding visual images for a simulation, in accordance with one embodiment of the system and method of the invention. Additionally, the data recording portion 120 may be operated without interfering with the test system operation during an actual rail inspection.

The image/data processing portion 130 in the data input control portion 100 converts the raw visual image and rail inspection data to a form suitable for storage and future use in creating a test scenario for the operator of the rail test simulator 10. Further, the image/data processing portion 130 creates stored data in a form that facilitates synchronization of stored visual images with test data. As one skilled in the art should appreciate such synchronization is required when the visual images and test data are presented to the operator of the rail test simulator 10 in a test scenario. Synchronization may be accomplished in any one of a number of ways, as described below.

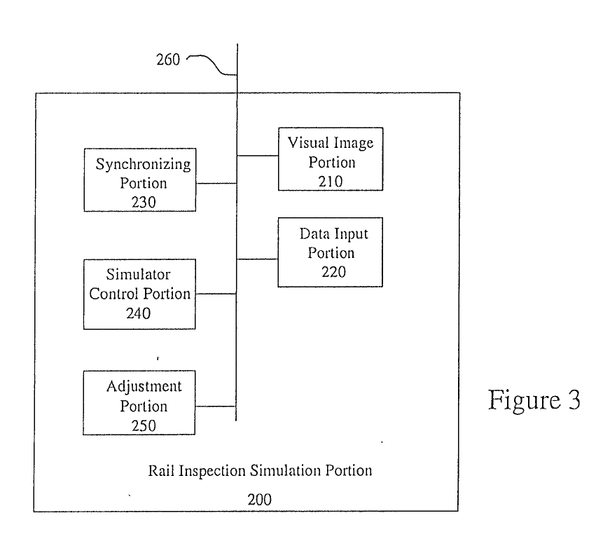

FIG. 3 shows in further detail the rail inspection simulation portion 200 of FIG. 1. As shown in FIG. 3, the rail inspection simulation portion 200 of the rail test simulator 10 includes a visual image portion 210, a data input portion 220, a synchronizing portion 230, a simulator control portion 240 and an adjustment portion 250. The visual image portion 210 provides an image of rail and surrounding area comparable to the image that an operator would observe from the viewing window of a test vehicle. Typically, the visual images used are those obtained by the data input control portion 100 of the simulator. The data input portion 220 provides test data of the type acquired by instrumentation used in rail inspections. Typically, test data would be data acquired by the data input control portion 100 and, for example, may be ultrasonic test data, induction test data or any other instrument data that is indicative of rail defects. Since the interplay between an operator's observation of visual images of the rail and test data obtained from instrumentation is needed for successful inspection, in accordance with embodiments of the system and method of the invention, a synchronizing portion 230 synchronizes appropriate visual cues with instrumental data, i.e., visual images with test data.

The simulator control portion 240 in the rail inspection simulation portion 200, permits the operator using the simulator to respond to visual images and test data in a manner that mimics an actual rail inspection. This includes the ability to slow down a test vehicle, back up a test vehicle, stop a test vehicle for a closer inspection, annotate test data and the like. More particularly, these functions may include, for example but are not limited to simulator functions that mimic stopping the vehicle at any random location to enable suspect signals to be investigated; backing up the vehicle on the track to perform tie ins or repeat runs; marking and recording the raw data with the operator's suspect annotations; changing the speed at which the vehicle is performing the test, i.e., increasing or decreasing the rate of speed; fully simulating the operational test vehicle's data display system and test functionality; providing a visual feedback system of the track as viewed from the vehicle's rear window that is locked with the raw data being output to the operator display; providing a visual image that has locked the vehicle's movement on the track in both the forward and reverse direction; producing a blurred or interference free image, both when the vehicle is moving and in a static position similar to that which would normally be experienced on a test vehicle; producing auto alarms of the type that are normally found in a rail inspection vehicle test system to alert the operator of major suspect indications; and providing a mileage location simulation to enable the operator to determine the vehicles exact location and track at any time.

Further, it is preferable that the simulator control portion 240 should be transparent to the operator. That is, it is preferable that the simulated experience appear as if real. For example, a dummy vehicle control panel may be used so that the simulator operator experiences a physical situation as close to the physical situation of an actual test vehicle as possible.

As described above and shown in FIG. 3, the rail inspection simulation portion 200 includes an adjustment portion 250. The adjustment portion 250 permits adjustment of synchronized visual images and/or data input to correspond to control selections initiated by the operator. For example, if the operator selected the option of backing up the vehicle in the simulator control portion 240, the adjustment portion would adjust visual images and test data to correspond to backing up the test vehicle. Typically, this adjustment is accomplished with a computer system.

Optionally, the rail inspection simulation portion 200 may also contain a monitoring portion which permits recording and playback of an operator's decisions and performance for post analysis and verification after the termination of a training session. Preferably, post verification analysis is linked with the visual information. Additionally the rail inspection simulation 200 portion may provide for an instructor to remotely monitor a simulator operator's performance or for the instructor to selectively present test scenarios to the operator.

A user of the rail test simulator 10, i.e., a human person, includes not only the simulator operator who is responding to test scenarios but also, for example, a user entering data into the data input control portion 100 or an instructor monitoring operator performance. A “user” as used herein means anyone utilizing the rail test simulator 10 in any manner, while an “operator” is one type of user. Specifically, an operator is a user operating the simulator control portion 240 in response to a test scenario.

As will be appreciated by individuals knowledgeable in the art, the system is preferably computer based and any number of types of computer devices or other operating systems may serve as a suitable data processing machine for the system of the invention. Illustratively, a portable personal computer (PC) may be used in the practice of the invention.

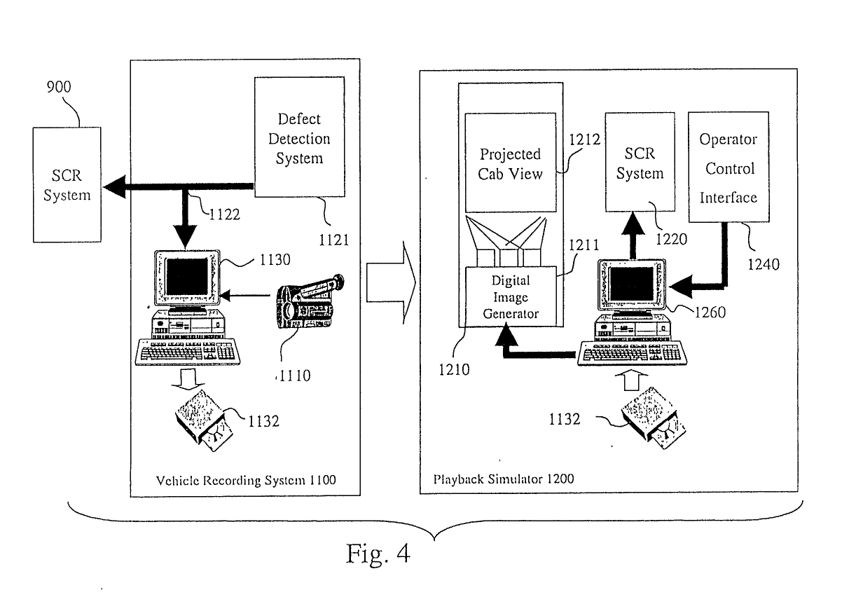

FIGS. 4-13 illustrate further aspects in accordance with one embodiment of the system and method of the invention. The system as shown in FIG. 4 includes a diagram showing a vehicle recording system 1100 and a playback simulator 1200. The vehicle recording system 1100 includes a defect detection system 1121, an SCR system 900, an image data processing portion 1130, and a cab digital image camera 1110. A data path 1122 connects the defect detection system 1121, the SCR system 900 and the image/data processing portion 1130. Also, the cab digital image camera 1110 is in communication with the image/data processing portion 1130. Accordingly, the cab digital image 1110 may transfer input image data to the image/data processing portion 1130.

The image/data processing portion 1130 contains a suitable memory for retaining inputted data. Stored data in the image/data processing portion 1130 may be transferred to an external data store 1132 as is necessary or desired.

As shown in FIG. 4, the vehicle recording system 1100 captures and records test data of the type used for a simulation during the operation of an actual test vehicle, i.e., during actual testing. The test data acquired by the vehicle recording system 1100 includes test data generated by the defect detection system 1121 and visual images from the cab digital image camera 1110. The test data from the defect detection system 1121 is acquired in real time during an actual test by the vehicle recording system 1100. Data generated by the defect detection system 1121 is output to both the image/data processing portion 1130 and the test vehicle output display 900. This duel output permits duel output the recording of data by the vehicle recording system 1100 during an actual rail test without interference with the data acquisition needed to perform the actual ongoing rail test.

Illustratively, the test vehicle output display 900, shown in FIG. 4, may be a modified strip chart recorder (SRC) system which displays data on a monitor screen and/or a paper chart.

As described above, accumulated data including both test data from the defect detection system 1121 and visual data from the cab digital image camera 1110, are input to the image/data processing portion 1130. This accumulated data may then be transferred to the external data store 1132. For example, the external data store 1132 maybe in the form of a diskette, compact disc, or other suitable storage medium. The external data store 1132 provides ease in transfer of accumulated data.

As shown in FIG. 4, the playback simulator 1200 in accordance with one embodiment of the system and method of the invention includes a computer 1260, an operator control panel interface 1240, a modified strip chart recording (SCR) system 1220, and a digital image generator 1211. The projection video 1211 generates a projected cab view 1212, as show in FIG. 4. The digital image generator 1211 and projected cab view 1212 collectively form the cab image portion 1210. The playback simulator 1200 may also include an external data store 1132. Accordingly, accumulated data from the vehicle recording system 1100 described above may be transferred to the playback simulator 1200 using the external data store 1132.

The embodiment of the invention shown in FIG. 4 illustrates the use of rail test data acquired during an actual rail test. It should be understood by one skilled in the art that test data and visual images simulated in another way, such as computer generated data and/or images, may also be used in the playback simulator 1200. The computer generated data maybe created to simulate situations that are not easily obtainable from real life testing, for example. The computer generated data may be generated in any suitable manor as is described further below.

The playback simulator 1200, as shown at FIG. 4, uses data provided from the vehicle recording system 1100 to drive an output which includes the cab image portion 1210 and the SCR system 1220 an image/data processing portion 1260, and an operator vehicle control panel 1240. The cab image portion 1210 includes a digital image generator unit 1211 which generates a projected cab view 1212. The digital image and test data are synchronized by synchronization software which is located in the image/data processing portion 1260. When the synchronized digital image and test data are presented a test scenario is created to which the simulator operator may respond by operating suitable controls via the operator vehicle control panel 1240 just like an operator would on a normal test vehicle. Accordingly, the vehicle playback simulator 1200 as shown in FIG. 4 includes a digital image generator capability which provides the operator with a simulated visual image display 1212 of the rail that is synchronized to the test data which is displayed using the SCR system 1220. The operator, by selecting appropriate controls on the operator control interface 1240, can regulate the flow of the data on the playback simulator 1200 by activating controls which simulate modification and movement of the test vehicle. Suitable operating software in the image/data processing portion 1260 adjusts the data displayed by the SCR system 1220 and/or the cab image 1212 displayed by the digital image generator portion 1210 in a manner consistent with options selected by the operator.

FIG. 4 illustrates that the vehicle recording system 1100 includes an image/data processing portion 1130 and the playback simulator 1200 includes an image/data processing portion 1260. Accordingly, the vehicle recording system 1100 and the playback simulator 1200 included separate processing portions. Data may be transferred between these two separate processing portions utilizing external data source 1132, for example. However, it should be appreciated that in accordance with an alternative embodiment, one processing portion may be utilized for both the vehicle recording system 1100 and the playback simulator 1200. Alternatively, the vehicle recording system 1100 and the playback simulator 1200 may utilize multiple computers connected in a suitable network system.

To enable the vehicle playback simulator 1200 to easily emulate an test vehicle's output display it is useful that the playback simulator 1200 utilize an output display identical to an actual test vehicle such as the SCR System 1220 shown in FIG. 4. Optionally, it is desirable that image/data processing portion allow recording the operator's performance, enabling playback and subsequent evaluation of operator performance.

In accordance with embodiments of the system and method of the invention, the visual image recording portion 110 as shown in FIG. 2 may be a variety of devices. Illustratively, the visual image recording portion 110 maybe in the form of a digital image. A digital image recording may be preferred to a video tape recording and playback system for a variety of reasons, including: as the simulator operator moves the vehicle along the test track, information needs to stay in synchronization with the test data; there is a need to allow the simulator operator to vary the speed of the playback rate when the video data may have been originally recorded at a different speed by the recording system; and the visual playback system needs to be able to produce an undistorted visual image of the track when the simulator operator decides to stop the vehicle. Further, there is a requirement to be able to move the simulator vehicle in both a forward and backwards direction without distorting or creating interference on the simulator's visual display. It is difficult to synchronize test data information to a video images on a VCR system unless the information is directly recorded on the video tape; and digital video information can be more readily controlled by computers.

More specifically, one example of suitable equipment for preparing a record of the visual images of the track is a high quality Super VHS video camera operating with an electronic shutter system. When obtaining visual images during a rail test, the camera is typically located on the actual test vehicle so that the camera provides the same field of view that the operator would normally see when seated at the rear of the test vehicle. Recording in this fashion permits the visual data to subsequently be viewed by an operator of the simulator in a manner which displays the track as it would be viewed from the rear of a test vehicle at a size equivalent to the normal observed size of the track.

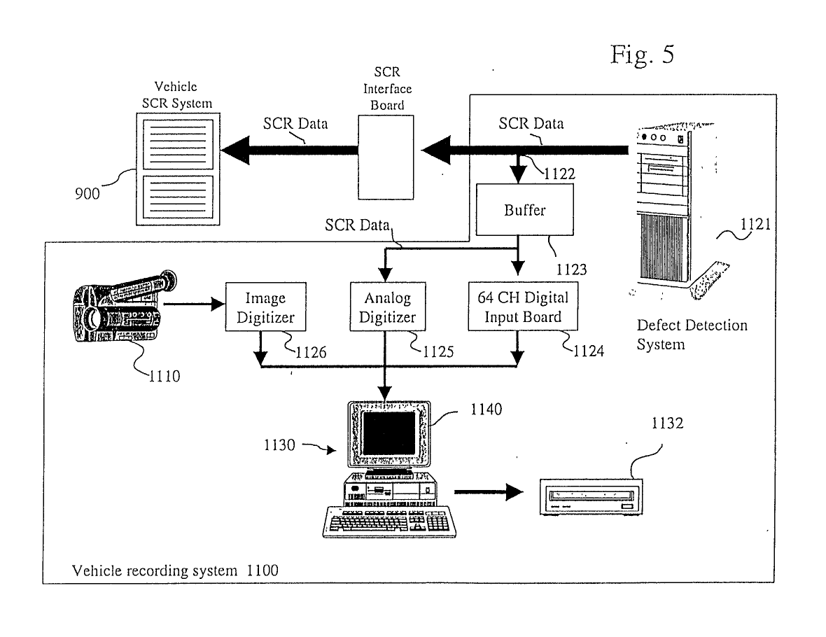

Referring to FIG. 5, the illustrative vehicle recording system 1100 as shown in FIG. 4 for acquiring test data and visual images in real time will be described in further detail. In accordance with one illustrative embodiment of the invention, in the vehicle recording system 1100 shown in FIG. 5 the data signal from the defect detection system 1121 is split by a data path 1122 between the vehicle recording system 1100 and the rail test vehicle data system 900. This arrangement allows a test vehicle to continue to operate as a normal test vehicle while data is being recorded for the simulator system.

The components of the exemplary vehicle recording system 1100 include the defect detection system 1121, an electronic buffer 1123, a digital input board 1124, an analog digitizer card 1125, an image digitizer 1126, a digital image camera 1110, and an image/data processing portion 1130. The components of the exemplary recording system function as described below: The defect detection system 1121 collects and provides the principle instrument test data, i.e., in this embodiment test data associated with ultrasonic testing, to the vehicle recording system 1100 in addition to providing data to the test vehicle display SCR system 900. This information is provided to the vehicle recording system via the electronic buffer 1123 to insure that the vehicle test system is isolated from the vehicle recording system 1100. Not all of the SCR input data is required for the vehicle recording system 1100. Examples of desirable information include: the vehicle's synchronization signal, which provides information from the vehicle tachometer every ⅙th of an inch and is used as the main timing to input digitized/read the analogs and digital inputs to the vehicle recording system; the vehicle landmark reference inputs which change state whenever a landmark reference input switch is pressed by the vehicle driver which are then used to trigger the landmark icons on the test display. Other desirable information includes the audio alarm trigger output which is used to trigger the vehicle's defect audio alarm whenever a major defect is detected by the instrumentation and which may be used to trigger a similar alarm during the simulation; a silver box analog pen outputs which are used to drive the analog part of the modified SCR, i.e., digital SCR or paper chart system; and decision outputs from the defect detection system which are digital outputs from the defect/induction decision making logic which are used to drive the digital SCR or paper chart system.

Illustratively, the information listed above may be logged into the vehicle recording system's computer at a rate of once every ⅙th of an inch, i.e., synchronization rate, or once about every 3 inches, i.e. synchronization divided by 18.

The vehicle recording system of the illustrative embodiment shown in FIG. 5 is provided with a digital input board 1124. The digital input board 1124 is used to read the digital outputs from the detection system 1121 and then transfer this data onto the vehicle recording system's image processing portion 1130, e.g., computer/hard disk. It is recommended that the digital input card read up to 64 individual digital inputs as this would be required to digitize the amplitude information from the 8 analog inputs typically used every sync pulse or ⅙th of an inch and then transfer this data to the vehicle recording system's computer/hard disk. An analog digitizer card 1125 may also be required to digitize the amplitude information from analog inputs and transfer this data to the vehicle recording system' computer and to introduce delay factors to some of the signals to compensate for mechanical offsets relating to testing equipment such as mechanical offsets of the transducers used in ultrasonic test equipment.

In the illustrative embodiment of FIG. 5 an image digitizer card 1126, is used for digitizing the image information from a high resolution camera 1110 converting it in digital image and then transferring the data to the vehicle recording system's image processing portion 1130 on the computer/hard disk. The information in this example is recorded in a format suitable for outputting to a strip chart recorder via high speed serial links.

As one skilled in the art will appreciate, the physical location of the buffer 1123, the image digitizer 1126, analog digitizer 1125 and digital input board 1124 may be in any number of locations including, but not limited to, a computer, a stand alone unit, or as a component of the video camera 1110 or defect detection system 1121, for example.

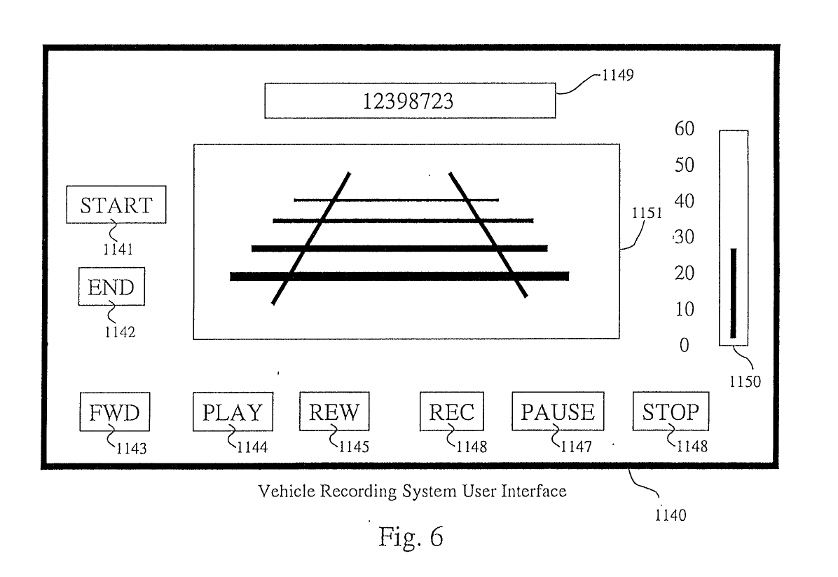

As shown in FIG. 5, the vehicle recording system of the illustrative embodiment is controlled by a simple user interface 1140 accessed via the computer terminal. The user interface 1140 is shown in more detail in FIG. 6. As shown in FIG. 6 the principal features of the user interface 1140 are a start button 1141 to initiate the vehicle recording process, a REC button 1148 to start the recording process, a PAUSE button 1147 to pause or hold the recording process, a STOP button 1148 to stop any active function on the vehicle recording system but not to finish the data recording process, a PLAY button 1144 to play back any portion of the recorded information, fast forward 1143 and rewind 1145 buttons to move backwards or forwards through the video captured by the recording session, and an END button 1142 to close the recording file. Further, the system is provided with a viewing screen 1151 such that the captured video image is displayed in real time during the recording process and provision is made for showing both the exact location of the recording system of the recorded file data on file data record 1149 and the amount of time left in the recording system on time log 1150.

Again referring to FIG. 5, the digitized images and test data may be synchronized or locked together to enable visual cues to be properly correlated with instrument data when the visual and test data are presented to the simulator operator in the rail inspection portion 1200. One example of a method to accomplish synchronizing of visual images with corresponding test data as well as enabling the vehicle recording system's computer to be able to read and store information without data processing clashes is to tag each piece of data with a unique synchronization code address (sync code). This sync code is generated by either a hardware or software counter (sync counter) that keeps track of the accumulated number of sync pulses that have occurred whenever the vehicle recording system is capturing data. This counter operates in a similar fashion similar to the tape counter on a VCR. For the system described in this illustrative embodiment, which is designed to capture data for up to an hour, the maximum data input rate the system is required to handle is 2 kHz (500 u seconds). For this input rate the sync counter would need to provide a count up to 7.2 EE 6, which requires a 23 bit counter driven by sync. Visual images and test data tagged with a sync code are sync code data.

Both the data from the defect detection system 1121 data and the digitized images 1126 are tagged with a unique sync number because each data stream will be asynchronous with each other due to variations in the vehicle testing speed e.g., typically 5-13 MPH and the fixed frequency of the video frame rate which is typically 30 Hz. The aim of this sync tag is to lock the two data streams together so they can eventually be played back synchronized with each other when an operator utilizes the simulator. During the process of recording data, the data may be stored on a computers' hard drive and at the end of the recording process data is preferentially transferred to optical disks/CD ROMs. These CD ROMs are then used when the operator manipulates the playback simulator 1200.

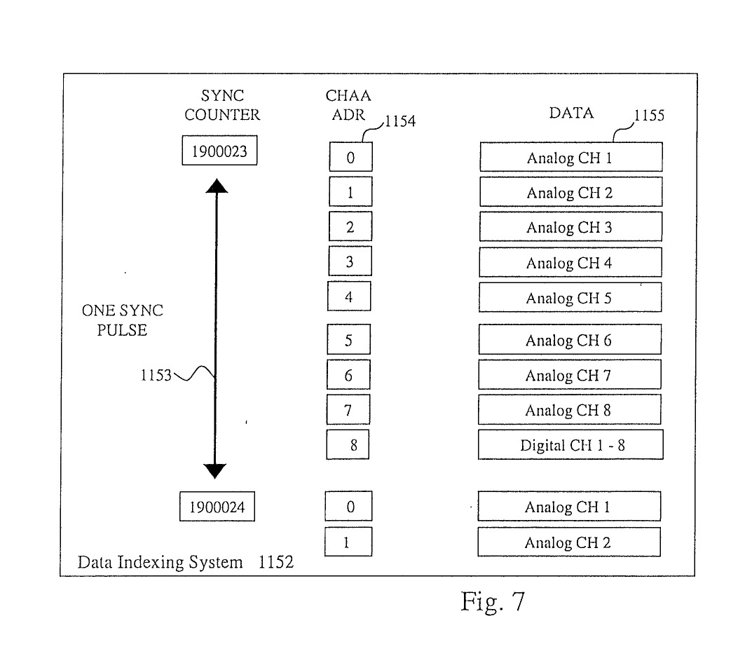

FIG. 7 shows an exemplary data indexing system 1152 which may be used with the sync code data. The data indexing system is a 3 bit indexing system which provides a base address index location for each of 8 channels of the 8 bit analog information at sync rate and the 8 channels of 8 bit digital information at a sync rate divided by 18. This coding system synchronizes the test data with the sync counter. The each channel of analog data 1155 is assigned a channel address 1154. The channel addresses are then correlated with the with a sync pulse number 1153. The data associated with one sync pulse 1153 is one byte of information.

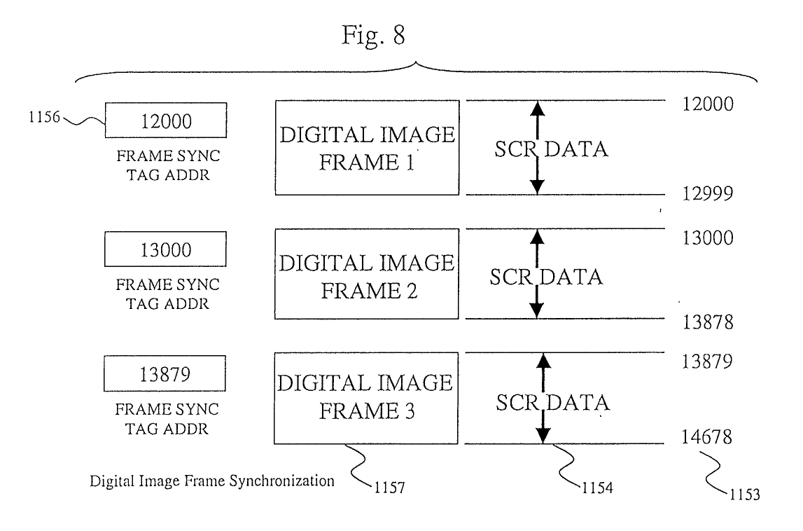

FIG. 8 shows synchronization of each digitized image 1157 with the sync code test data channel address 1154 and the data sync pulse number 1153. In the system as described, the digitized image rate is always slower than the test data sync rate, e.g., at 1 MPH by a factor of 3. As shown in FIG. 8, each digitized frame 1157 is processed by the vehicle recording system 1100 and tagged with the last stable sync counter address, i.e. frame sync tag address 1156 prior to being stored. This enables the playback system 1200 to use the sync information from the previous, current, and next digitized frame to determine the range of test data to which the current view frame correlates.

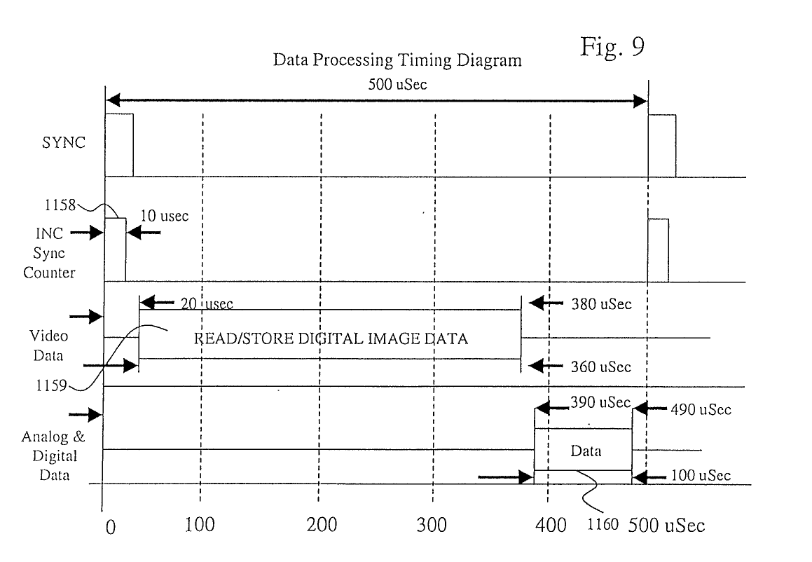

Referring again to FIG. 5, signals from the analog digitizer card 1125, the digital input board 1124 and image digitizer card 1126, may be processed as shown in FIG. 9. From FIG. 9 it can be seen that the 500 u sec data processing window of the system of the illustrative embodiment has been further broken down into 3 discrete processing periods and that these are all timed from the sync input signal. A first processing period 1158 of 10 u sec is to allow the sync counter to be clocked with the sync pulse and increment its output by 1. A second processing period 1159 of 360 u sec occurs 10 u sec after the first processing period 1158 and this second period 1159 is used to transfer the image information from the digitizer card to the system hard disk. In this instance, the image information has a much lower repetition rate so it is also possible to time division multiplex this process. A third processing period 1160 of 100 u sec which occurs 10 u sec after the second processing period 1159 is used to read and store the digitized data from the 8 analog channels and 1 byte of information from the digital input card, e g., the data associated with one sync pulse 1153 as shown in FIG. 7, is written to hard disk. On completion of the third processing period 1160, the analog digitizer card 1125 goes into its acquisition mode to digitize the 8 analog inputs ready for the next processing period. In addition to accomplishing processing and storing the desired information, the process timing is designed to insure that the main system processor does not suffer from clashes, due to data acquiring and requiring servicing at the same time.

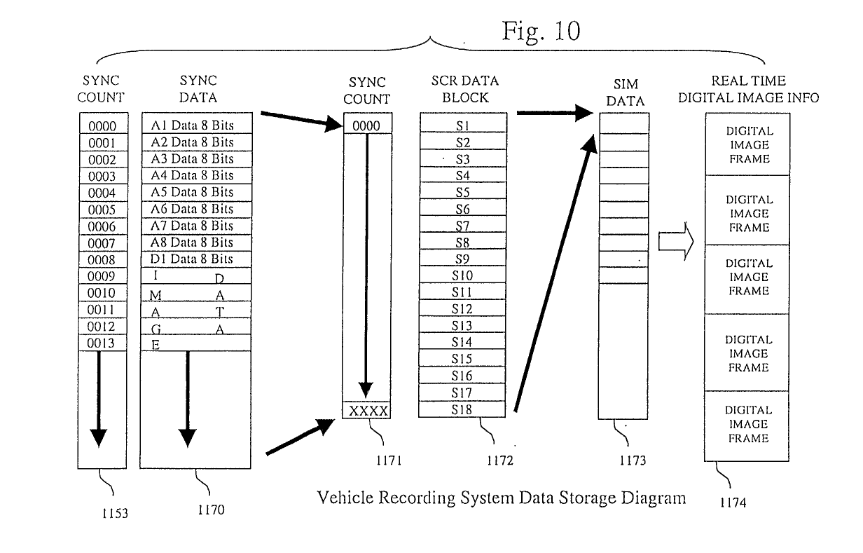

FIG. 10 provides a representation of the conceptual data storage allocation in the memory of the vehicle recording system. [Do we need further discussion of this storage system?]

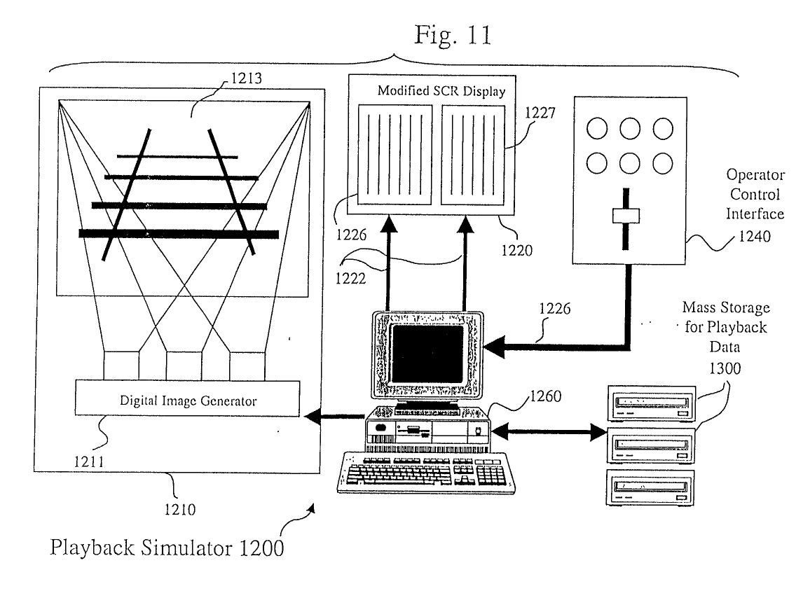

An illustrative embodiment of a playback simulator 1200, as discussed above, for the rail inspection simulation portion 200 of the rail test simulator shown in FIG. 1 is shown in detail in FIG. 11. The playback simulator 1200 includes the operator control interface 1240, a modified SCR system 1220, a computer 1260, and a video image portion 1210. The primary function of the playback simulator 1200 is to reconstitute the test data and digitized images recorded by the vehicle recording system 1100 and permit the operator of the rail test simulator using the operator control interface 1240 to respond to this data with choices, conditions, and options mimicking an actual test situation. Further, once an operator has initiated a response in the operator control interface 1240, the presentation of the input data and the digitized images are modified by software to reflect the settings of the operator control interface with the adjustment portion which is included in the computer 1260. The digitized images and test data are modified in a manner consistent with the way in which the images and data would be modified when an operator elects a particular control response in an actual testing situation.

As shown in FIG. 11, test data presented in the playback simulator 1200 is fed into a modified SCR system 1220 which includes analog display 1226 and digital display 1227. The functionality and output of the SCR system 1220 is preferably identical to systems used on an actual test vehicle. Thus, the simulator operator is able to pick and mark suspect indications in the same way as would be done on a normal operational vehicle. Further, the resultant test data of the simulator is preferably stored by the SCR system in exactly the same format as on a typical track test vehicle. This allows the operators performance to be assessed using playback software used in actual operation test vehicles.

The digitized image portion 1210 shown in FIG. 11 presents the cab image 1213 to the user of the playback simulator via a digital image generator unit 1211. The digitized image is linked with the test data such that visual cues are presented simultaneously with related test data presented by the modified SCR system 1220, for example. The cab image 1213 is preferably a full size image of track as viewed from the rear of an actual test vehicle when data was recorded. By utilization of the synchronization method described above, video data is digitized and tied to the SCR data movement such that the cab image data changes in harmony with the vehicle's movement both in forward and reverse directions. Further, when the vehicle is static, the cab image is also static.

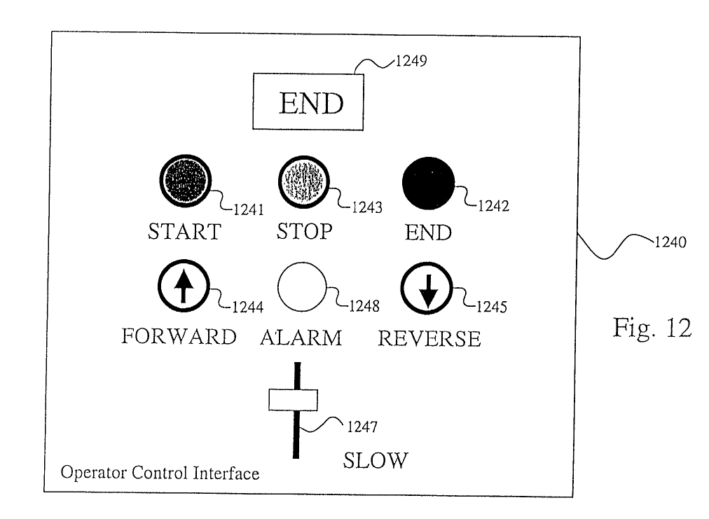

As shown in FIG. 11, the playback simulator 1200 includes an operator control interface 1240. A simulator operator manipulates the control portion of the simulator via the operator control interface 1240. FIG. 12 shows an illustrative embodiment of the operator control interface 1240 and the control functions available to an operator. In a typical simulator, the control functions include a start button 1241 that starts the playback of data and images from the simulator and starts the apparent movement of the vehicle at slow speed, an end button 1242 that stops the playback of data and images and closes the current test run, a stop button 1243 that will freeze the simulator data equivalent to stopping an actual test car; and forward 1244 and reverse 1245 direction switches which cause the simulator to output data and images in either the forward or reverse direction and is equivalent to moving the car in either forward or reverse direction. Additionally, the control functions may include vehicle speed control 1247 which allows the simulator operator to control the apparent speed of the simulation and is equivalent to increasing or decreasing the speed of the actual vehicle; audio alarm output 1248 which replicates the defect alarm on a normal test vehicle; and an end simulator light 1249 to indicate that a simulator/operator has finished a simulation.

In the illustrative embodiment shown in FIG. 5, the sequential counting process described above is used for acquisition and storage of test data and cab images. Referring again to FIG. 11, the same sequential counting process may be used to read the test data and cab images in the playback simulator 1200. As the sync counter is incremented, the test analog data is output at sync with the required sync rate, the test digital data is then output at sync divided by 18 and the cab image is output whenever the value of the sync counter corresponds to the digitized image frame address/tag value. Thus, varying the rate and direction of the sync counter, the speed and direction of the vehicle can be simulated by computer. Linking the sequential counting process to the operator interface 1240 of the control portion of the simulator allows the operator to simulate control of the vehicle. Stopping the vehicle is mimicked by stopping the counting.

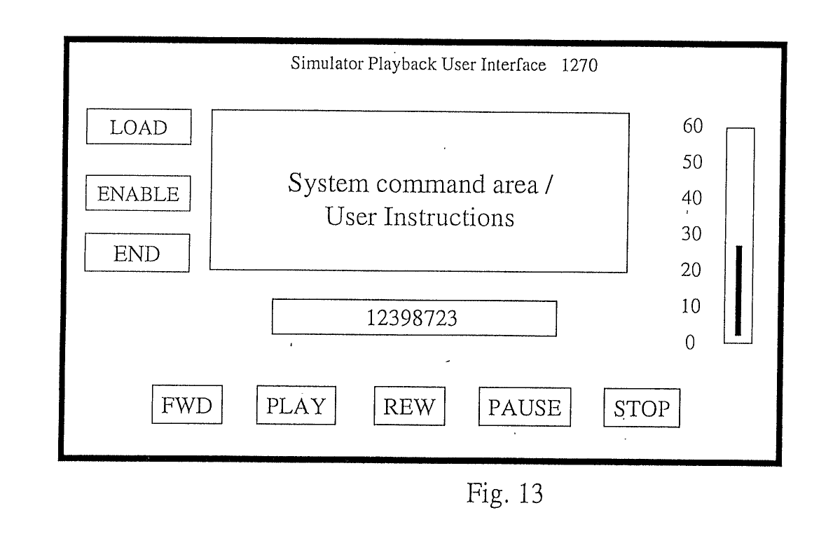

To facilitate and expedite use of the simulator, the simulator may optionally have a user interface. An exemplany embodiment of a user interface 1270 is shown in FIG. 13. The user interface 1270 has a primary function of controlling the loading and playback of simulator data. That is, the user interface 1270 allows a user of the simulator to move to a particular point in a simulation without viewing the entire simulation. The user interface is designed to facilitate use of the simulator as an instructional tool. For example, it may be used by an instructor to select and focus a particular type of defect to present to the simulator operator as opposed to presenting an entire set of simulation data to the simulator operator.

Additionally it is desirable that the system also contain a monitoring portion which permits recording and playback of operator's decisions and performance for post analysis and verification. Preferably, post verification analysis is linked with the visual information. Additionally the system may include capability for an instructor to remotely monitor a simulator operator's performance.

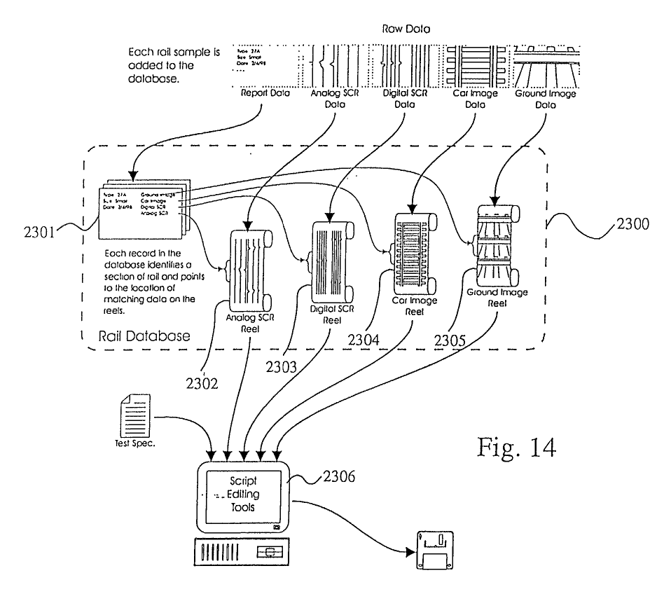

As mentioned above, acquiring visual images and test data for use in the rail test simulator 10 and presenting the simulator operator with in essence an exact copy of an actual rail test is one of many ways of collecting data in the data input control portion 100. As shown in FIG. 14, data collected during a rail inspection may be organized in a library 2300 with multiple data bases of report data 2301, analog test data 2302, digital test data 2303, car image data 2304, and ground image data 2305, for example. These data bases may be selectively utilized using a script editing software 2306 to create a virtual rail line complete with defects and associated test data; thus, creating a highly customized set of test scenarios for use in the rail inspection simulation. Once created this customized set of tests scenarios may be preserved on computer drive, diskette or CD for future use. Computer generated simulations of data and images are yet another of the many examples of methods for obtaining test data and visual images.

It will therefore be readily understood by those persons skilled in the art that the present invention is susceptible to a broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention.

Accordingly, while the present invention has been described herein in detail in relation to its exemplary embodiments, it is to be understood that this disclosure is only illustrative and exemplary of the present invention and is made merely for the purposes providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims.

What is claimed is:

1. A rail test simulator system for training an operator comprising:
a rail test data recorder for obtaining obtained rail test data, the rail test data recorder including:
a visual image recording portion for recording obtained visual data, the obtained visual data representing a plurality of visual images; and
a data recording portion for recording a plurality of obtained track data, the obtained track data representing a condition of a track), the obtained rail test data including the obtained visual data and the obtained track data; and
a rail inspection simulator that simulates a track inspection, the rail inspection simulator including:
a visual image generation portion that generates generated visual images based on the obtained visual data;
a track data generation portion that generates generated track data based on the obtained track data; and
a controller that inputs the obtained rail test data from the rail test data recorder from the rail test data recorder, the controller providing the obtained visual data to the visual image generation portion and the obtained track data to the track data generation portion, the controller including:
an operator interface portion, the operator interface portion accepting operator input from an operator, the controller providing the obtained rail test data to the visual image generation portion and the obtained track data to the track data generation portion based on the operator input.

2. The rail test simulator system according to claim 1, wherein the controller synchronizes the visual image generation portion and the track data generation portion such that generation of the generated visual images and generation of the generated track data is synchronized.

3. The rail test simulator system according to claim 2, wherein the visual image generation portion and the track data generation portion generate the generated visual images and the generated track data from the obtained visual data and the obtained track data tagged with unique identification numbers, the controller synchronizing the visual image generation portion and the track data generation portion by referencing the unique identification numbers.

4. The rail test simulator system according to claim 1, wherein the data recording portion records the obtained track data during an actual rail inspection during travel over a rail.

5. The rail test simulator system according to claim 1, wherein the data recording portion records the obtained track data from data generation simulation.

6. The rail test simulator system according to claim 1, wherein the data recording portion records at least one of ultrasonic rail test data and induction rail test data.

7. The rail test simulator system according to claim 1, wherein the visual image recording portion is a digital image recorder.

8. The rail test simulator system according to claim 1, wherein the rail inspection simulator further includes an instructor portion, the instructor portion including:
An instructor control portion; and
An instructor monitoring portion.

9. The rail test simulator system according to claim 1, wherein the rail inspection simulator includes an instructor monitoring portion, the instructor monitoring portion monitors the generated visual images, generated track data and operator input.

10. The rail test simulator system according to claim 7, wherein the instructor control portion accepts instructor input, the instructor control portion providing the instructor input to the controller, wherein the controller provides the obtained visual data to the visual image generation portion and the obtained track data to the track data generation portion based on the instructor input.
